(19) United States
(12) Patent Application Publication
(10) Pub. No.: US 2021/0392818 A1
(43) Pub. Date: Dec. 23, 2021

(54) TREE BRANCH BUNDLING ASSEMBLY

(71) Applicants: Ahmed Afify, Katy, TX (US); Marwan Afify, Katy, TX (US)

(72) Inventors: Ahmed Afify, Katy, TX (US); Marwan Afify, Katy, TX (US)

(21) Appl. No.: 16/908,840

(22) Filed: Jun. 23, 2020

(51) Int. Cl. A01F 1/02; B65B 27/10; B65B 13/20

(52) U.S. Cl. CPC A01F 1/02; B65B 13/20; B65B 27/10

(57) ABSTRACT

A tree branch bundling assembly includes a base that has a bottom side, a top side, a front side, a rear side, a first lateral side and a second lateral side. A first receiver extends upwardly from the first lateral side. A second receiver extends upwardly from the second lateral side. The first and second receivers each have an open upper side for receiving branches. A spindle is rotatably attached to the front side. A pair of spindle eyelets is attached to the spindle. A pair of receiver eyelets is attached to the base adjacent to the rear side. A first tether is attached to one spindle eyelet and one receiver eyelet. A second tether is attached to the other spindle eyelet and receiver eyelet. The first and second tethers are extendable around branches and the spindle rotated to tighten the first and second tethers around the branches.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to branch bundling device and more particularly pertains to a new branch bundling device for facilitating the bundling together a plurality of branches such as would be acquired from the pruning of trees.

### (2) Description of Related Art Including Information Disclosed Under 37 CFR 1.97 and 1.98.

The prior art relates to branch bundling devices used to hold branches while the branches are bound together.

### BRIEF SUMMARY OF THE INVENTION

An embodiment of the disclosure meets the needs presented above by generally comprising a base that has a bottom side, a top side, a front side, a rear side, a first lateral side and a second lateral side. A first receiver is attached to and extends upwardly from the first lateral side. A second receiver is attached to and extends upwardly from the second lateral side. The first and second receivers each have an open upper side for receiving branches. A spindle is rotatably attached to the front side and is positioned adjacent to the top side. A pair of spindle eyelets is attached to the spindle wherein each of the first and second lateral sides has one of the spindle eyelets positioned adjacent thereto. A pair of receiver eyelets is attached to the base adjacent to the rear side. Each of the first and second lateral sides has one of the receiver eyelets positioned adjacent thereto. A first tether is attached to the spindle eyelet and the receiver eyelet positioned adjacent to the first lateral side. A second tether is attached to the spindle eyelet and the receiver eyelet positioned adjacent to the second lateral side. The first and second tethers are extendable around the breaches positioned in the first and second receivers and the spindle rotated to tighten the first and second tethers around the branches.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a tree branch bundling assembly according to an embodiment of the disclosure.

FIG. 2 is a side view of an embodiment of the disclosure.

FIG. 3 is a bottom view of an embodiment of the disclosure.

FIG. 4 is a front view of an embodiment of the disclosure. FIG. 5 is a side in-use view of an embodiment of the disclosure.

FIG. 6 is a front isometric view of an embodiment of the disclosure.

FIG. 7 is a front isometric view of an embodiment of the disclosure.

### DETAILED DESCRIPTION OF THE INVENTION

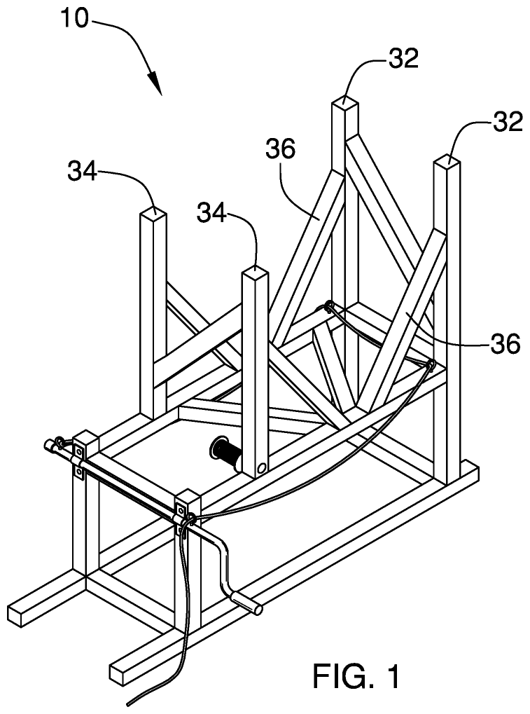

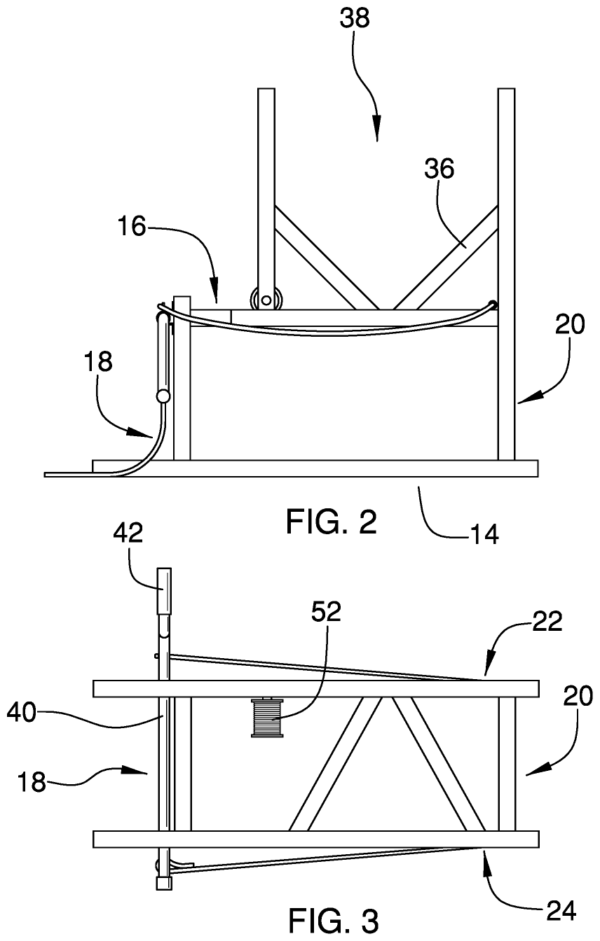

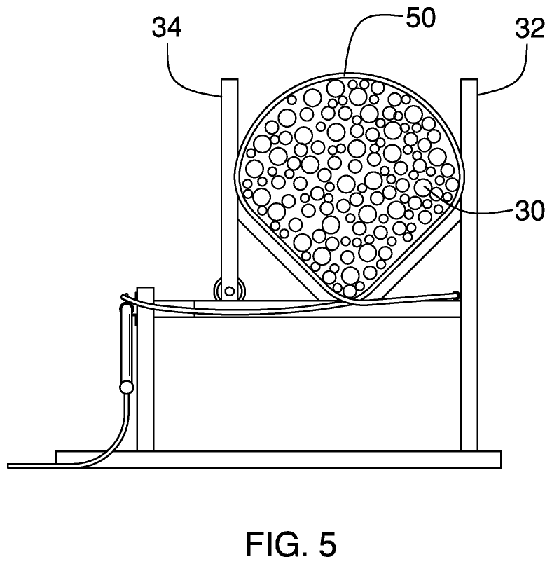

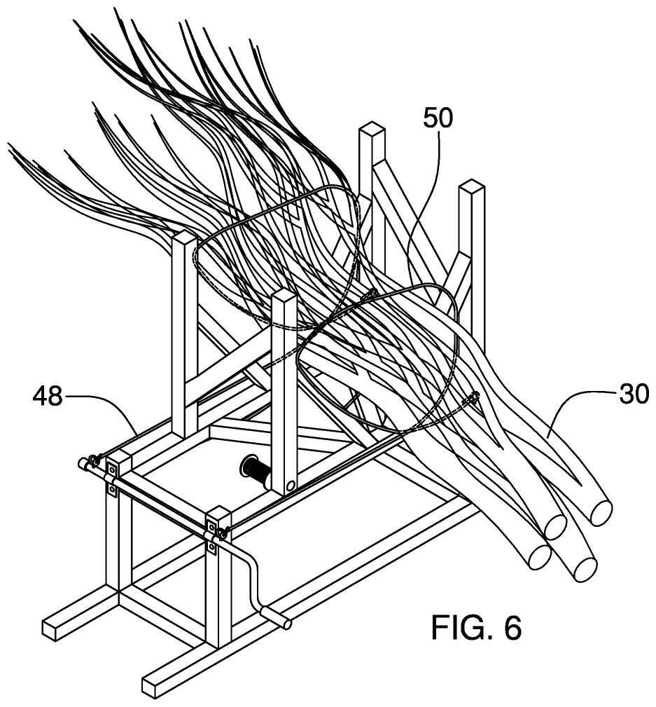

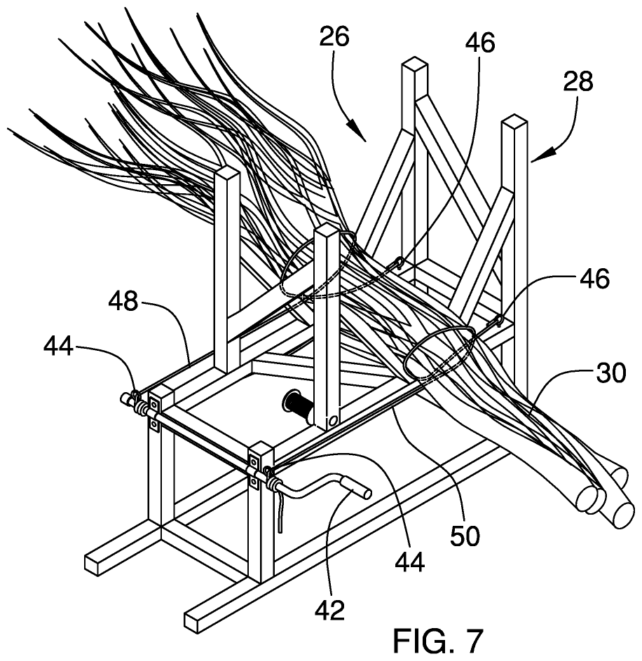

With reference now to the drawings, and in particular to FIGS. 1 through 7 thereof, a new branch bundling device embodying the principles and concepts of an embodiment of the disclosure and generally designated by the reference numeral 10 will be described.

As best illustrated in FIGS. 1 through 7, the tree branch bundling assembly 10 generally comprises a base 12 having a bottom side 14, a top side 16, a front side 18, a rear side 20, a first lateral side 22 and a second lateral side 24. The base 12 has a height between 12.0 inches and 48.0 inches.

A first receiver 26 is attached to and extends upwardly from the first lateral side 22. A second receiver 28 is attached to and extends upwardly from the second lateral side 24. The first 26 and second 28 receivers each have an open upper side for receiving branches 30. Each of the first 26 and second 28 receivers is positioned adjacent to the rear side 20 and spaced from the front side 18 a distance equal to at least 6.0 inches. The first 26 and second 28 receivers each extend upwardly from the base 12 a distance of between 14.0 inches and 30.0 inches.

Each of the first 26 and second 28 receivers comprises a first rod 32 and a second rod 34. The first rod 32 is positioned adjacent to the rear side 20 and the second rod 34 is positioned nearer to the front side 18 than the rear side 20. A receiving space 38 is positioned between the first 32 and second 34 rods. A wedge 36 extends between the first 32 and second 34 rods. The wedge 36 is V-shaped and urges branches 30 toward a center area of the associated receiving space 38.

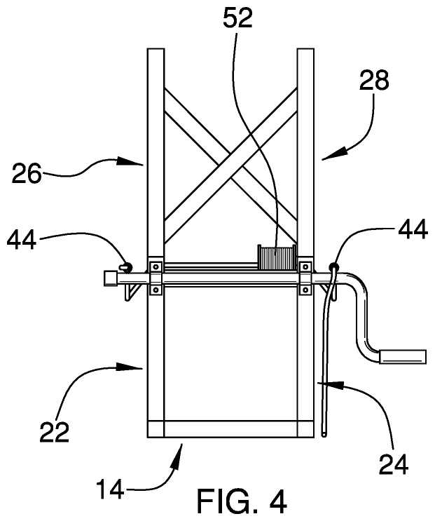

A spindle 40 is rotatably attached to the front side 18 and is positioned adjacent to the top side 16. A handle 42 is attached to the spindle 40 to facilitate the rotation of the spindle 40. A pair of spindle eyelets 44 is attached to the spindle 40 wherein each of the first 22 and second 24 lateral sides has one of the spindle eyelets 44 positioned adjacent thereto. As can be seen in FIG. 3, the spindle eyelets 44 are positioned laterally of the base 12.

A pair of receiver eyelets 46 is provided. The receiver eyelets 46 are attached to the base 12 adjacent to the rear side 20. Each of the first 22 and second 24 lateral sides has one of the receiver eyelets 46 positioned adjacent thereto.

In use, a first tether 48 is attached to the spindle eyelet 44 and the receiver eyelet 46 positioned adjacent to the first lateral side 22. A second tether 50 is attached to the spindle eyelet 44 and the receiver eyelet 46 positioned adjacent to the second lateral side 24. The first 48 and second 50 tethers are extended around the breaches 30 positioned in the first 26 and second 28 receivers to form a loop around the branches 30. The spindle 40 is then rotated to tighten the first 48 and second 50 tethers around the branches 30. The first 48 and second 50 tethers are then tied to retain the branches 30 in a bundled condition. A spool 52 may be rotatably mounted on the base 12 to hold additional tether to be used as needed. Alternatively, a single tether may be utilized which is attached to one spindle eyelet 44, extended through the receiver eyelets 46 and tied to the other spindle eyelet 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A branch receiving assembly configured to facilitate bundling together of a plurality of branches, the assembly including:
a base having a bottom side, a top side, a front side, a rear side, a first lateral side and a second lateral side;
a first receiver being attached to and extending upwardly from the first lateral side, a second receiver being attached to and extending upwardly from the second lateral side, the first and second receivers each having an open upper side for receiving branches;
a spindle being rotatably attached to the front side, the spindle being positioned adjacent to the top side;
a pair of spindle eyelets being attached to the spindle wherein each of the first and second lateral sides has one of the spindle eyelets positioned adjacent thereto;
a pair of receiver eyelets, the receiver eyelets being attached to the base adjacent to the rear side, each of the first and second lateral sides having one of the receiver eyelets positioned adjacent thereto;
a first tether is attached to the spindle eyelet and the receiver eyelet positioned adjacent to the first lateral side;
a second tether is attached to the spindle eyelet and the receiver eyelet positioned adjacent to the second lateral side; and
wherein the first and second tethers are extendable around the breaches positioned in the first and second receivers and the spindle rotated to tighten the first and second tethers around the branches.

2. The branch receiving assembly according to claim 1, wherein the base has a height between 12.0 inches and 48.0 inches.

3. The branch receiving assembly according to claim 1, wherein each of the first and second receivers being positioned adjacent to the rear side, each of the first and second receivers being spaced from the front side a distance at least equal 6.0 inches.

4. The branch receiving assembly according to claim 1, wherein the first and second receivers each extend upwardly from the base a distance of between 14.0 inches and 30.0 inches.

5. The branch receiving assembly according to claim 1, wherein each of the first and second receivers comprises a first rod and a second rod, the first rod being positioned adjacent to the rear side, the second rod being positioned nearer to the front side than the rear side, wherein a receiving space is positioned between the first and second rods.

6. The branch receiving assembly according to claim 5, wherein each of the first and second receivers each includes a wedge extending between the first and second rods, the wedge being V-shaped.

7. A branch receiving assembly configured to facilitate bundling together of a plurality of branches, the assembly including:
a base having a bottom side, a top side, a front side, a rear side, a first lateral side and a second lateral side, the base having a height between 12.0 inches and 48.0 inches;
a first receiver being attached to and extending upwardly from the first lateral side, a second receiver being attached to and extending upwardly from the second lateral side, the first and second receivers each having an open upper side for receiving branches, each of the first and second receivers being positioned adjacent to the rear side, each of the first and second receivers being spaced from the front side a distance equal to at least 6.0 inches, the first and second receivers each extending upwardly from the base a distance of between 14.0 inches and 30.0 inches, each of the first and second receivers comprising:
a first rod and a second rod, the first rod being positioned adjacent to the rear side, the second rod being positioned nearer to the front side than the rear side, wherein a receiving space is positioned between the first and second rods;
a wedge extending between the first and second rods, the wedge being V-shaped;
a spindle being rotatably attached to the front side, the spindle being positioned adjacent to the top side;
a pair of spindle eyelets being attached to the spindle wherein each of the first and second lateral sides has one of the spindle eyelets positioned adjacent thereto;
a pair of receiver eyelets, the receiver eyelets being attached to the base adjacent to the rear side, each of the first and second lateral sides having one of the receiver eyelets positioned adjacent thereto;
a first tether is attached to the spindle eyelet and the receiver eyelet positioned adjacent to the first lateral side;
a second tether is attached to the spindle eyelet and the receiver eyelet positioned adjacent to the second lateral side; and
wherein the first and second tethers are extendable around the breaches positioned in the first and second receivers and the spindle rotated to tighten the first and second tethers around the branches.
